(19) United States
(12) Patent Application Publication
(10) Pub. No.: US 2016/0111918 A1
(43) Pub. Date: Apr. 21, 2016

(54) Domestic and Residential Uninterruptible Power Supply

(71) Applicant: Mark Edwin BENSON, Buckingham, Buckinghamshire (GB)

(72) Inventor: Mark Edwin Benson, Buckingham (GB)

(21) Appl. No.: 14/893,968

(22) PCT Filed: May 23, 2014
(86) PCT No.: PCT/GB2014/051591

§ 371 Date: Nov. 25, 2015

(30) Foreign Application Priority Data
May 28, 2013 (GB) 1309500.5
May 20, 2014 (GB) 1408963.5

(51) Int. Cl. H02J 9/06; H02J 3/38; B60L 11/18; H02J 7/00

(52) U.S. Cl. CPC H02J 9/061; H02J 7/0068; H02J 3/383; H02J 3/386; B60L 11/1809

(57) ABSTRACT

A standby domestic power storage and supply for a domestic or residential premises, and establishments comprising: a battery or equivalent power storage device; (with or without a backup) and optionally single or three phase supply to suit the available space and specific standby demands an AC/DC converter for converting between a direct current and alternating mains current; and a system of renewable power systems integrated with the mains supply and the standby storage supply to afford mains feed in or alternatively top up of the electrical power storage device. An integrated wiring system suited for installing in new premises or retrofitting to accommodate power existing or new distribution boards. Especially the addition of a new essential power distribution board being fed from the mains or from the standby power storage unit when mains power fails. A new essential distribution board to provide essential power to dedicated and or critical power points. This is achieved using typically a 3 way switch either manually or remotely controlled to serve such critical items as a dialysis machine a medical fridge of an electric vehicle etc. This electric vehicle can also be used to top up the standby power storage device. A control system for controlling interaction of the battery or equivalent storage device with one or a plurality of domestic electrical circuits and/or electrical devices. The circuit includes integrated relays that change the flow of electricity to and from the mains supply or the standby power supply as and when a power failure occurs It also enables the renewable supplies to serve and top up the standby power device (UPS) when there is an outage or when the UPS needs topping up. In addition there are back feed preventers type G59 or equal that ensure power does not return up the incoming supply wiring as and when an outage occurs. There are isolators located such that items of equipment can be isolated during periods of maintenance and repair. There is the option of a wired control loop for the purpose of monitoring and controlling the system in an integrated manner.

### FIELD OF THE INVENTION

The present invention relates to a reserve electrical power supply for Domestic and Residential premises and farms stables, veterinary properties and clinics. More particularly, but not exclusively, it relates to a domestic uninterruptible power supply linked to renewable energy sources.

While in industrialised countries domestic consumers may usually be able to rely on a continuous mains electrical power supply, there are still circumstances in which the mains power may be lost. Extreme weather conditions can bring down above-ground power lines, particularly in heavy snow. District transformers can go out of action, due to routine component failure, extreme weather or even theft or attempted theft of vital components and wiring. Whenever the mains power supply is lost, most of the functions of the modern dwelling will also be lost.

This loss of power can be life-threatening in situations such as where a resident is dependent on home dialysis equipment, due to kidney problems. A further medical crisis might occur where a resident is dependent on medication that must be stored under refrigeration. Thus, prolonged loss of power would render an entire stock of medication, kept for home administration, unsafe and unusable.

Less life-threatening but still extremely inconvenient consequences of loss of power include thawing of foodstuffs in domestic freezers and refrigerators left too long without power.

Security alarms and fire alarms usually have a small internal back-up battery power supply, but once this is exhausted, they may fail to operate. Many systems interpret a sudden loss of power as a trigger condition for the alarm to be set off, interpreting loss of power as an attempt to sabotage the alarm, for example. As electrically powered private cars become more and more widely used, their users will become more and more reliant on a home recharging station to recharge their vehicle's batteries overnight from the mains power supply. If the domestic power supply fails, the driver may find that the vehicle has little or no power and so cannot be used. One other problem that can arise is where greenhouses, hot houses, or the like are kept warm by domestic electrical heating, and so loss of mains power may result in tender seedlings or exotic plants dying of cold. Similar problems may endanger tropical fish and small animals kept in cages. Most house or flats will have multiple electrical or electronic systems, the operation of which is considered critical.

Various proposals have been made for domestic power back-up systems. Renewable sources of power might help, but photovoltaic (PV) systems will only be of use in daytime, while the greatest problems from loss of power will occur at night.

Wind power systems will be of limited help in either low wind speeds or very high wind speeds (when most wind turbines must be feathered to avoid over-speeding). Very high wind speeds are of course likely to be associated with weather conditions that are likely to cause mains power failure.

However the use of wind turbines are considered useful especially for normal weather conditions and allow feed in to the grid or replenishment of the internal backup storage power supply.

The PV Arrays in certain locations can be used to create an artificial draught across the turbine blades due to the flow of air across the arrays and employing a state of art wind funnel thus assisting operation of the wind turbine.

While commercial premises, medical facilities and the like are often provided with automatic diesel-powered generators, these are not generally used in a domestic setting, except in the most isolated and or rural locations.

It is hence an object of the present invention to provide an apparatus capable of storing electrical power on domestic premises or the like and delivering power to critical household systems on the loss of a mains electrical power supply, which is of a size and weight which is acceptable in a domestic situation, and which provides enough standby power capacity to run essential domestic or Residential electrical equipment in the event of temporary power outage.

It is a further object to provide a standby power storage apparatus for storing electrical power at a domestic premises, which can integrate with a range of domestic renewable or low carbon energy sources such as a combined heat and power generator & boiler, a photovoltaic solar array, a wind turbine generator, an electric vehicle docking station, a fuel cell, or the like, and which provides power alongside those devices in the event of a mains power cut.

It is a further object to provide a standby power storage apparatus for storing electrical power at a domestic premises which can be charged either by mains power, or by a domestic renewable energy source or low carbon energy source such as a photovoltaic solar cell array, a CHP boiler, a fuel cell, or a wind turbine generator, thereby providing local power storage of renewably generated energy, or energy generated using other low carbon technology devices.

It is a further object to provide a standby power storage apparatus for storing electrical power at domestic premises which can integrate with a household's electric powered or low carbon powered vehicles, by sharing electrical energy with such vehicles, to transfer energy to those such and/or to receive energy from such vehicles.

The type of storage cell employed can be powered from either a single phase supply more suited to a medium size property and with restricted backup supply through the essential distribution board.

However for the larger type of residence such as a small hotel old persons residence a farm, riding stables or vetinary establishment or clinic The use of a three phase supply would be advantageous as it provides a longer backup time period and affords a full charge for critical outlets such as an electric vehicle or car or dialysis machine.

Where sufficient space is available for the electrical storage batteries or cells a further option is backup storage systems whether single or three phase mains supply.

In respect of employing additional backup storage systems and especially for the three phase it allows the main distribution board to be selectively connected to the standby power during times of power failure or fault.

The mains power supply should advantageously be complimented by a low tariff economy or equal meter as commonly used for single phase residential mains power supplies.

This would enable recharging of the electrical storage system (U P S) In respect of a proposed three phase mains supply the tariff would be subject to negotiation with the electrical power provider.

This recharging would normally occur during the night hours.

A secondary benefit with having a low tariff metered supply would allow the maintaining or installation of secondary storage heaters.

These would provide back ground heating during periods of power outage as well as during periods of normal mains power provision.

### SUMMARY OF THE INVENTION

According to a first aspect of the present invention, there is provided a domestic uninterruptible power supply, locatable within a dwelling, comprising electrical power storage means, operatively connectable to a mains power supply so as to be provided with electrical power thereby; at least one renewable energy source select ably operatively connectable to the electrical power storage means so as to supply electrical power thereto; power distribution means select ably operable to connect the electrical power storage means to critical systems of the dwelling so as to supply them with electrical power; and control means for the power supply, wherein said control means is so adapted as to respond to failure of the mains power supply by operatively connecting the at least one renewable energy source to the electrical power storage means and by operatively connecting the electrical power storage means to the power distribution means.

Preferably, the control means is adapted to respond to failure of the mains power supply by providing electrical power to activate the at least one renewable energy source.

An important element when utilising the standby power system is to ensure that an electrical current whether from the renewable power systems or the storage system is not allowed to back feed into the supply mains and in the case of a domestic electrical system failure or fault the electrician can isolate sections of the circuit to enable safe repair or maintenance.

Advantageously, there are a plurality of said renewable energy sources. Said renewable energy sources may comprise devices selected form the following set: wind turbine generators; water turbine generators; photvoltaic solar cells; fuel cells; combined heat and power (CHP) generators; electric vehicles.

The at least one renewable energy source may comprise a means of converting solar energy to electrical power, such as photovoltaic (PV) panel means.

The at least one renewable energy source may comprise a means of converting wind energy to electrical power, such as wind turbine means.

The at least one renewable energy source may comprise a means of converting temperature differences to electrical power.

Preferably, the electrical power storage means is adapted to provide both alternating current (AC) and direct current (DC) electrical power.

The electrical power storage means may then be provided with invertor circuit means adapted to produce said DC electrical power.

Preferably, the control means is operable so as to connect the electrical power storage means to the mains power supply only during periods when electrical power is supplied from the mains power supply at a reduced cost (economy tariff). Using the economy 10 also offers the use of background electrical storage heaters supplementing the standard wet heating system that might shut down during a power failure or fault.

The control means may be operable so as to connect the electrical power storage means to the mains power supply only during periods when the 5 mains power supply is under reduced load, for example at night.

Preferably, the electrical power storage means comprises a plurality of electric storage battery cells or fuel cells.

The power distribution means preferably comprises a standby electrical distribution board means, separate from a conventional electrical distribution board means of the dwelling that is linked directly to the mains power supply.

The standby power distribution means may be operatively connected to power a pump of a solar-heated hot water system, said pump passing water through panel means heated by solar radiation to produce a domestic hot water supply for washing and/or central heating.

The power distribution means may be operatively connected to the at least one renewable energy source so as to provide electrical power to trigger or activate it or indeed test its function.

The power distribution means may be operatively connected to a fire alarm system and/or a burglar alarm system of the dwelling, optionally via a dedicated uninterruptible power supply of said alarm system.

The power distribution means may be operatively connected to medical equipment located within the dwelling.

The power distribution means may be operatively connected to heating and/or lighting means of the dwelling, optionally in only predetermined rooms of the dwelling.

The power distribution means may be operatively connected to power socket means of the dwelling, optionally only to a proportion of said power sockets.

Said proportion of the power socket means may then be used to power equipment and systems of the dwelling that are considered most important or critical.

The electrical power supply means may be operatively connectable to charging means for an electrically-powered vehicle.

The electrical power supply means may then be adapted selectably to receive electrical power from the electrically-powered vehicle.

An electric power storage means of the vehicle may thus act as an auxiliary electrical power storage means for the domestic uninterruptible power supply if necessary.

Other aspects are as set out in the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 is a schematic representation of domestic uninterruptible standby power supply system embodying aspects of the present invention;

FIG. 2 shows schematically further details of the standby power supply system of FIG. 1 herein; and

FIG. 3 illustrates schematically a control system of the standby power supply system of FIG. 1 herein.

### DETAILED DESCRIPTION OF THE EMBODIMENTS

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

In the accompanying drawings, the following reference numerals correspond with the following items:
100: Fuse board
101: Economy 10 meter
102: Solar photovoltaic panel feed in meter
103: Wind turbine feed in meter
104: Solar array control electronics 30
105: Photovoltaic solar panel (s)
106: Wind turbine generator power board
107: Wind turbine
108: Battery powered storage or equal uninterruptable power supply
109: Hot water supply solar panel power board.
110: Hot water supply solar panel
111: Hot water supply solar panel pump
112: Electric or dual fuel vehicle or car
113: Storage heater distribution board
114: Mains ring circuit distribution board
115: Stand by power (essential/critical) distribution power board
116: Storage heater (s)
117: Storage heater (s)
118: Storage heater (s)
119: Electric cooker
120: Optional half hour power supply unit—fridge freezer
121: Fridge freezer
122: Fire alarm half hour power supply unit
123: Burglar alarm half hour power supply unit
124: Stand by power supply to medical equipment e.g. dialysis machine, medical store, optional hot water supply electric immersion heater, portable water pump or other system requiring critical backup power supply
125: Ring main external lights e.g. floodlights
126: Spur-immersion heater—domestic application
127: Ring main
128: Ring main
129: Heating pump—optional
130: Hot water supply pump—optional
131: Toaster or kettle or microwave
132: Burglar alarm
133: Fire alarm
134: Ground floor lights
135: First floor lights
136: Optional mini or standard single or 3-phase combined heat and power supply either mains gas or optional liquid propane gas or diesel as standby purpose.
137: Smart type (signal and monitor) main control device
138: 3 way switch combined with optional remote link-critical standby power.
139: workshop or garage or stables critical supply.
140: Electric vehicle standby single phase power supply
141: PC or laptop half hour power unit (PU)
142: PC or laptop
143: Wi-Fi half hour power unit PU
144: Wi-Fi Internet backup
145: Essential power the gas cooker ignition and or optional combined heat and Power ignition-see 159
146: Spare essential way-circuit
147: Single phase mains supply to hot water solar panel pump
148: Remote-Smart type (signal and monitor), device-optional
149: Backup (Tandem) universal power supply system-optional large house or establishment standby power supply
150: Mains feed in to the primary universal power supply system-single or 3 phase
151: optional universal power supply controller linked in
152: Optional remote or wired control loop (signal and monitor) system
153: Optional three-phase Mains fuse board for supply to universal power supply and full charge ELV
154: 3-phase meter-for 153 and large house or establishment supply
155: Single phase junction box—optional 3 phase for large house universal power supply and backup universal power supply and ELV full charge
156: Typical distribution board & UPS loads (amperes and or kVA)
157: Single phase branch feed to boost the type ELV charge point
158: Optional 3 phase branch feed to full charge type ELV charge point
159: Essential standby power branch to restart combined heat and power ignition on power failure
160: Common wiring the test/restart photovoltaic array turbine and hot water systems solar pump
161: Solar photovoltaic array(s) essential restart/test power supply
162: Wind turbine essential restart/test power supply
163: Hot water system pump essential restart/test power supply
164: Common single phase supply to mains and essential distribution board universal power supply and electric vehicle charge point
165: Ongoing supply to universal power supply and essential distribution board and electric vehicle charge point
166: Ongoing supply to uninterruptable power supply and essential distribution board
167: Branch supply to uninterruptable power supply and storage system
168 Ongoing mains single phase supply to essential distribution board
169: Link to supply power from UPS to essential distribution board
170: Single phase supply to mains distribution board (large house/residence or establishment.
171: Branch supply to the mains distribution board (DB)
172: Multiple or single photovoltaic array controller
173: Mains power supply to photovoltaic array for test or restart post photovoltaic repair
174: Common single phase mains and standby branch supply for test or restart photovoltaic array
175: Common photovoltaic array renewable supply feed in to mains or serve UPS or equal
176: Photovoltaic array mains feed in supply
177: Photovoltaic array renewable supply to UPS or equal.
178: Single phase mains power supply to wind turbine to test or restart
179: Common mains or standby branch supply the test or restart wind turbine
180: Common uninterruptable standby power supply or mains supply to essential distribution board.
181: mains supply the storage heaters
182: Electric vehicle charge point
183: Electric vehicle meter
184: Spare essential Ring main and as for large house
185: photovoltaic array-optional wind funnels serving the turbine-daylight hours use
186: mini combined heat and power waste heat boiler circuit link(s)
187: optional mini combined heat and power auto changeover (A C o S or ATS) on power outage or optional run
188: optional renewable and feed in system equivalent fuel cell or other
189: ring or radial main secondary mains power supplies
190: turbine renewable supply
191: turbine feed in to mains
192: Turbine feed in to U P S or equal standby power storage and supply System.
193: Optional standby single phase power supply to Main distribution board board (large house or property/establishment).
194: Electric vehicle boost charge to single phase universal power supply system only-optional
200: Storage Heater Distribution Board
201: Main Radial and Ring main Distribution Board
202: Essential Standby Distribution Board
203: Storage Heater Radial circuits
204: Main Distribution Board secondary ring or radial circuits
205: Secondary circuit to Solar HWS pump
206: Ground Floor Lighting circuit
207: First Floor Lighting circuit
208: Spare essential ring main
209: Common ring main various points
210: Ring or radial to fridge freezer etc.
211: Ring or radial to fire & burglar alarms
212: Secondary critical supply main to 3 way switch
213: Common secondary essential supply to re-start or test PV Array Turbine and Solar HWS Panel pump
214: Essential critical boost single phase supply to ELV Charge point
215: Essential critical supply to Dialysis or HWS immersion heater or equal
216: Essential critical supply to workshop garage or equal
217: Common essential supply to gas cooker ignition and or CHP ignition
218: Dedicated ongoing supply to CHP ignition (gas or diesel)
219: Optional 3 phase to UPS System
220: Optional 3 phase to charge E L V
221: Common Single phase supply
222: Single phase supply to UPS & Essential Board
223: Single phase supply to UPS or equal electrical store system
224 Single phase supply to Essential Board
225 Single phase supply from U P S to Essential Board
226: Common single phase mains or UPS supply to Essential Board
227: Standby U P S System supply for Mains Distribution Board Large House/Residence option
228: Single phase supply to boost E L V
229: Dedicated single phase supply to Mains Distribution Board
230: Single Phase or optional 3 phase for large House/Residence or establishment U P S or other storage System
231: Optional single or three phase Backup (Tandem) UPS System for House/Residence etc.
232: Single or optional Three phase mains supply
233: Single phase supply to storage heaters
234: Fuel supply to CHP System (A=S)
235: Automatic Changeover switch (or auto transfer switch) for backup supply to House/Residence
236: Solar P V Array (s) essential re-start/test power supply
237: Wind Turbine essential re-start/test power supply
238: HWS pump essential re-start/test power supply
239: Optional renewable & feed in system equivalent fuel cell or other
240: CHP waste heat pipework circuit & controls
300: Single phase fuse board
301: Optional 3 phase fuse board
302: Single phase E10 Economy meter
303: 3 phase meter
304: Single phase junction box
305: 3 Phase junction box
306: PC or lap top half hour Power Unit (P U)
307: PC or lap top
308: Wifi internet backup
309: Essential power to Gas Cooker ignition and or optional CHP ignition-see 159
310 Wifi half hour Power Unit P U
311 Spare way circuit to power point
312 Optional Half hour power supply unit—Fridge freezer
313: Fridge freezer
314: Toaster or Kettle
315: Microwave
316 Fire alarm half hour power supply unit
317: Fire alarm
318: Burglar alarm half hour power supply unit
319: Burglar alarm
320: 3 way switch c. w. optional remote link (339)—critical standby power and linked to control signal and monitor circuitry (335)
321: Electric Vehicle Charging point
322: Electric Vehicle Charging tariff meter (M)
323: H W S Solar Panel power board
324: H W S Solar panel pump
325: H W S Solar panel
326: Wind Turbine
327: Wind Turbine generator power board
328: Photovoltaic Solar panel (s)
329: Solar Array control electronics
330: Solar P V Panel feed in meter
331: Wind turbine feed in meter
332: CHP System & integral control electronics unit
333: Optional renewable & feed in system equivalent fuel cell or other
334: Electric or dual fuel Car or Vehicle (112)
335: Optional remote or wired control loop system
336: U P S system Control console/unit
337: Single phase junction box
338: Three phase junction box
339: Remote control device (F1)
340: Local Isolators to single or 3 phase supplies at powered Units to comply with electrical safety standards
A1 & A 2: Auto change over device (s)
AS1: Ambient temperature sensor
B1 & B2: Turbine power auto change over device (s)
D1 & D2: Daylight sensors (optional)
A C O S: Optional CHP power & Mains power Auto changeover switch
ATS Auto transfer switch as A C O S
S1 Mains power to UPS standby Auto changeover switch—Essential Board
S2 Mains power to Run & Standby UPS 2 Nr Auto changeover switch—Mains Board
B F P Back feed Preventer Normally closed on mains power outage/failure and being as type G 59 or equal or equivalent international standards
E 1 Isolator—Single phase circuit to E L V charge point
E 2 Isolator—Single phase to U P S
E 3 Isolator—3 phase to U P S System
E4 Isolator—3 phase to E L V charge point
E5 Etc. Local Isolators to all single or 3 phase supplies at powered Units to comply with electrical safety standards
Ref E1 to E5 etc. Isolators for local maintenance

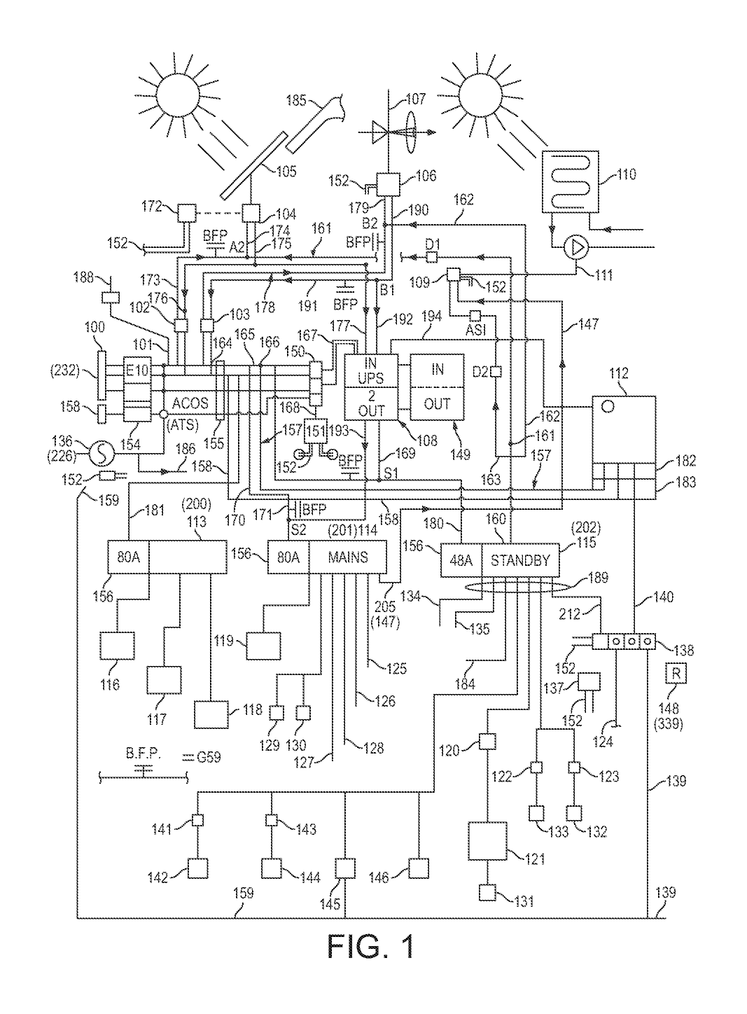

Referring to FIG. 1 herein, there is illustrated schematically in overview a domestic electrical circuit for a new or refurbished house, flat or other domestic dwelling, or establishment incorporating a standby uninterruptable power supply and control system according to a specific embodiment of the present invention.

The dwelling comprises a conventional domestic/residential ring main circuit; and a plurality of conventional renewable energy devices. The standby power apparatus comprises a battery pack, or equivalent storage system an ac/dc converter for converting between direct current energy stored in the battery pack or equal and an alternating current used on the domestic circuits, a control apparatus for controlling operation of the battery pack, and a separate dedicated standby power distribution board for distributing power supplied form the storage system. The standby power apparatus also includes a plurality of sensors AS1, D1, D2 which send signals to the controller for controlling one or a plurality of renewable or low carbon energy sources, and/or one or a plurality of electrical appliances or devices, and one or more local control devices, such as actuators, valves, switches or relays for controlling individual electrical devices or appliances to turn them on or off during periods of mains power interruption.

Part of the installation is as currently known in conventional domestic electrical installations, including mains fuse 100, an Economy 10 electricity meter 101, an 80 Amp mains distribution board 114, and an 80 Amp storage heater distribution board 113, together with conventional ring main circuits for lighting and heating, and for electrical storage heaters 116-118.

The installation also comprises an electric cooker 119; and optional half-hour pilot power supply unit for a fridge freezer 120; a fire alarm half-hour's power supply unit 121; a burglar alarm half-hour panel supply unit 123; a standby power supply 124 to medical equipment for example a dialysis machine, level 0 & 1, or for a hot water supply electric immersion heater; a ring main for external lights 125; a spur 126 for an immersion heater; a first ring main 127; a second ring main 128; a heating pump 129; a hot water supply pump 130; optionally a mini or standard single or 3 phase combined heat and power supply 136, either mains gas or optionally liquid propane gas or diesel as standby; a smart type signal and monitor main control device 137; a three-way switch optional remote link critical standby power 138; a workshop, garage or stables critical power supply 139; an electric vehicle standby power supply 140; a PC or laptop half-hour power unit 141 for powering a PC/laptop 142; a Wi-Fi half-hour power unit 143; a WiFi internet backup 144; essential power 145 to a gas cooker ignition or optional combined heat and power ignition; a mains supply to a hot water system solar panel pump 147; a remote smart type signal and monitor control device 148; a backup universal power supply system, optional large house standby power supply 149; a mains feed into a primary universal power supply system, single or three phase 150; an optional universal power supply controller which is linked in 151; and optional remote or wired control loop system 152; an optional three-phase mains fuse board 153 for supply to universal power supply and full charge electric vehicle; a three-phase meter 154; a single phase junction box 155 (optionally three-phase larger house universal power supply, and backup universal power supply and electric vehicle full charge); a typical distribution board & UPS load 156; a single phase branch feed 157 to boost type electric vehicle charge point; an optional three-phase branch feed 158 to full charge electric vehicle charging point; an essential standby power branch 159 to restart combined heat and power ignition on power failure; common wiring 160 to test/restart a photovoltaic array, turbine and hot water system solar power; one or more solar photovoltaic array power supplies 161 for essential restart/test; a wind turbine essential restart/test power supply 162; hot water system pump 163 essential restart/test power supply; a common single phase supply 164 to mains and essential distribution board, universal power supply and electric vehicle charging points; an ongoing supply 165 universal power supply and essentials distribution board and electric vehicle charging points; an ongoing power supply 166 to universal power supply and essential distribution board; a branch supply 167 to a an uninterruptable universal power supply; a main universal power supply 168 to a main distribution board for a large house, which is optional; and outgoing universal power supply 169 to mains or universal power supply links supply to essential distribution boards; an optional single phase supply 170 to mains distribution board (large house/residents supply); a branch 171 to mains distribution board; a multiple photovoltaic array controller 172; a power supply to a photovoltaic array for test or restart post photovoltaic repair 173; a common mains or standby power supply for test or restart photovoltaic array 174; a common photovoltaic array renewable supply 175; a photovoltaic array mains feeding supply 176; a photovoltaic array renewable supply to UPS or equivalent; a single phase mains power supply 178 to a wind turbine to test or restart; a common mains or standby power supply 179 to test or restart wind turbine; a universal power supply standby power or mains supply 180 to essential distribution board; a mains supply 181 to storage heaters; an electric vehicle charge 0.182; an electric vehicle meter 183; a spare essential ring main 184; a photovoltaic array 185, a mini combined heat and power waste boiler circuit link 186; an optional mini combined heat and power auto changeover 187 for use on power outage or optional run; an optional renewable and feeding system equivalent fuel cell 188 or similar; a ring or radial main secondary mains power supply 189; turbine renewable supply 190; turbine feeding to mains 191; and a turbine feed in to UPS 192 to single phase universal power system supply system; an optional standby single phase power supply to the main distribution board 193; an optional electric vehicle boost charge to single phase UPS 194; and any other power outlet point not necessarily included in this list but described elsewhere in the drawings herein.

In the specific embodiment described herein, a conventional domestic electrical circuit is augmented by incorporation of an uninterruptable power supply (or other electrical storage system) 108 together with a dedicated standby power distribution board 115, to supply emergency or standby power during periods of temporary interruption of mains power supply from the incoming electricity grid.

Domestic uninterruptible power supply (UPS) 108 comprises a battery pack, comprising a plurality of rechargeable electrical storage cells. Using modern battery technologies, such as lithium ion or nickel metal hydride batteries, a battery pack the size of an upright refrigerator freezer unit can currently store 8 kVA of electrical energy, which should be sufficient to power most critical and or selected essential services in a domestic or residential setting for long enough for an interrupted mains supply to be restored.

The single phase UPS storage system can be supplemented where space allows with a backup UPS in tandem (149) or indeed use of a three phase UPS or equivalent storage system to serve such establishments as farms stables small hotels and clinics the benefit of three phase allows a full charge to an electric vehicle. These 3 phase systems are 10 KVa or more.

The uninterruptable power supply unit 108 comprises an array of batteries, preferably lithium batteries or nickel cadmium batteries, together with an AC/DC converter, to convert between alternating current and direct current. In addition there is a control unit linked to a plurality of control sensors which serve to minimise or optimise energy usage during periods of mains power cut.

The AC/DC converter is co-located next to the battery pack. The control unit performs two functions. Firstly to manage power supply to devices which have high priority such as dialysis machines, medical equipment, or boost charging of electric vehicles and emergency lighting, etc. in preference to supplying power to lower priority uses such as controlling domestic heating, or the full recharging of electric vehicles; and secondly to optimise the use of power by turning off or directing power away from any unnecessary household electrical appliances, such as televisions, electric space heaters, water immersion heaters or the like.

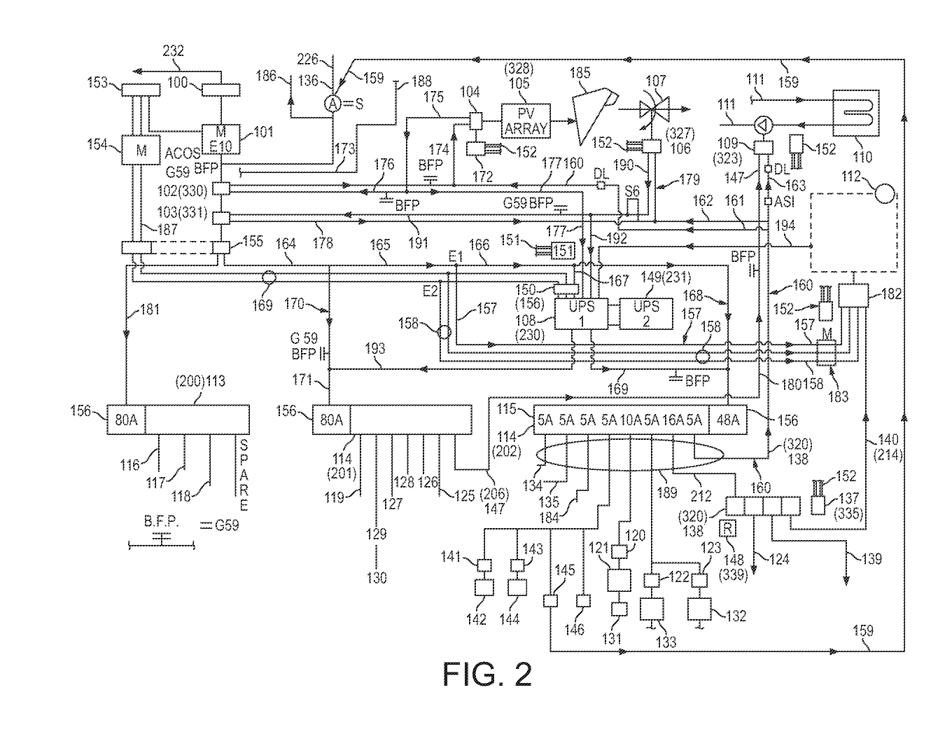

Referring to FIG. 2 herein, the household installation comprises an optional combined heat and electricity supply 136 which may then be connected to a storage heating distribution board 210, and/or a main power distribution board 211. Since the UPS 108 receives power from the same electrical supply as that to the main distribution board, the UPS can receive electrical energy from the CHP unit. In the best mode, the control unit switches any renewable energy sources to the UPS 108 on detecting a mains power cut.

Further components of the household installation of FIG. 2 are as listed and described with reference to the numerals herein above.

Solar panel 110 is operated by an electrical pump 111 which pumps fluid around the solar panel, which feeds a separate water circuit to a central heating boiler. The pump 111 is controlled by an ambient temperature relay AS1 which senses the temperature outside the house, turning off the pump, to prevent circulation of low temperature water, and only operating the solar panel when the sun is sufficiently strong to heat the water in the panel. Additionally, there is a daylight sensor DL or D1, which is connected to the standby power distribution board 115. Both the ambient temperature relay AS1 and the daylight sensor DL or D1 continue to receive power from the standby distribution board 115 during a power cut, so that the solar panel can still be operated and managed during a mains power cut.

Wind turbine generator 107 has incorporated a control circuit which receives power from wind turbine generator board 106 (327) so that operation of the control circuitry to the wind turbine can be controlled during conditions of mains supply power cut. For example, if there is sufficient wind for the turbine to generate electricity during the power cut, the control electronics to the turbine will be kept activated by power from the UPS. However, if there is insufficient wind to operate the wind turbine efficiently, then power supply to the control electronics for the wind turbine can be switched off during times of mains power cut, to conserve energy.

The photovoltaic solar array 105 is connected to a daylight sensor DL or D1, which receives power from the standby power distribution board so that the operation of the solar array can still be controlled during conditions of mains power supply cut.

Standby power distribution board 115 is reserved for devices or appliances which are either critical, or have high priority for electricity usage during a period of power cut. The house may be fitted with specific ring main circuits connected to the standby power supply, to which high priority equipment may be connected, such as medical equipment, or power supplies to telephones, WiFi apparatus or computers where office work might be based.

Mains power distribution board 114 supplies a plurality of mains power ring circuits, for example an electric cooker spur, a spur to a hot water immersion heater element, and ring mains, which may supply additional kettles, personal computers electric fires, radios and connecting in hoovers, washing machines and dishwashers or the like.

Other ring main circuits from the mains power distribution board 114 include ring mains to ground or first floors, ring mains which supply central heating pumps, and external ring mains for external house lighting, garage lighting or garage sockets. For premises which do not have mains water, but which rely on bore hole pumps and electric ultraviolet light for filtering bacteria, these may be connected to the standby power distribution board 115, so that the household can maintain its water supply during power cuts.

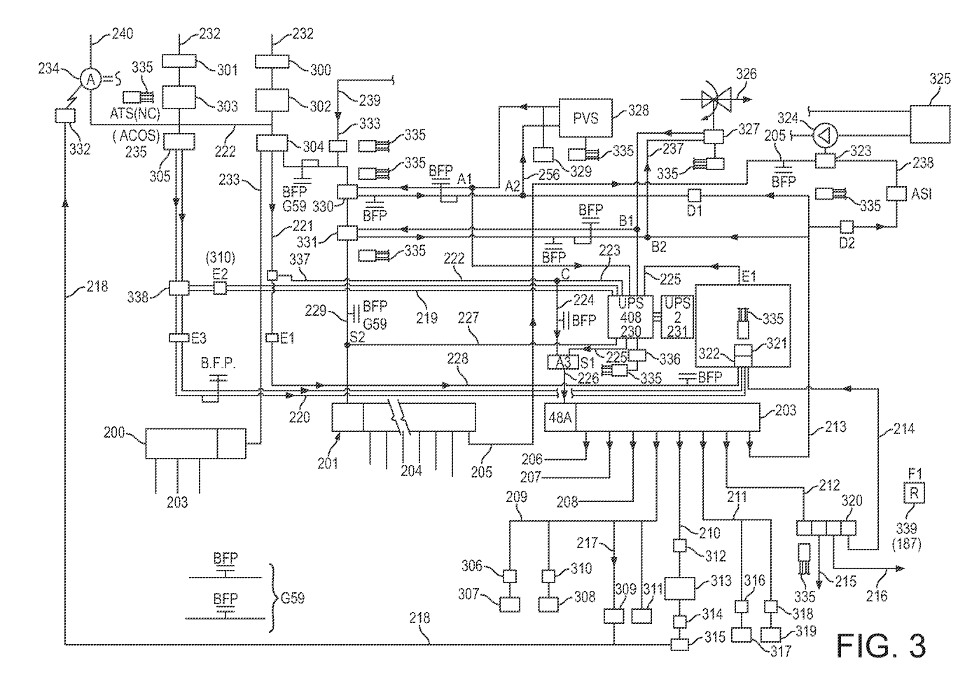

Referring to FIG. 3 herein, there is illustrated schematically components of the control system for controlling the standby power supply system.

The photovoltaic array 328 (105) is controlled by a relay A1 which automatically changes over the connection of the output of the photovoltaic array from the normal mains junction box 330 (102) to the input to the universal power supply, during mains power cut. Therefore, the solar array can direct power either to the mains distribution board, during normal mains present conditions, or direct its output to the UPS, during mains power cut conditions.

Similarly, the output of the wind turbine is controlled by relay switches B1, B2 to direct the output of the wind turbine to the mains distribution board, or the UPS and standby power distribution board.

For control of the solar panel 325 (110), this is controlled by the solar panel pump 324 (111) which in turn is controlled by daylight sensor D2, and ambient temperature sensor AS1, which receives power supply from the renewables trigger circuit 213.

In FIG. 3 herein, the reference numerals listed above correspond to corresponding items as shown in FIG. 3 herein.

The power supply system also comprises one or more back feed preventers (BFP (s) and being type G59 or equal, local isolators (E1 etc.) and also the option of a control loop, as well as a remote control.

### Overview of Operation

FIGS. 1 to 3 herein indicate the electrical circuitry and mechanics of a typical new build or retro fit stand by power supply system serving residential properties which can be installed or retrospectively fitted, to enable essential power supply to a home. The core of the system is a standby power storage and supply unit (uninterruptable power supply system). The critical or stand by power supply should be routed through a conventional distribution board properly earth wired and integrated in parallel to the houses standard power supply wiring system. The UPS system enables temporary supply for up to 60 minutes and 120 minutes with renewables operational, also for 3 phase essential load the temporary supply can be up to 120 minutes and more with renewables operational on utility power supply failure or in a house power systems failure or breakdown. The UPS unit draws its power from the mains via an economy 10 low cost rate meter, so it is charged during a 5 hour overnight, afternoon or evening boost. The UPS unit activates when there is either a power outage or a power failure in the home. The UPS power standby device serves ground and first floor lighting and fire and security alarms as well as computer and information technology access points. Importantly, it ensures that renewable energy sources such as photovoltaic and wind turbine renewable energy supplies, and fuel cells remain on during the mains power outage. Subject to available wind, a wind turbine can run 24 hours 7 days a week including during the night, whereas photovoltaic cells only provide renewable power during daylight hours. Fluid filled solar panels provide warming to make up water to a domestic hot water system during daylight hours, but during night time may need to be turned off. Therefore, the universal power supply only provides power to the photovoltaic cells and solar panel when a daylight sensor indicates that there is enough daylight to run these devices efficiently, and in the case of the solar panel, when the outside temperature is high enough. If there is either not enough daylight or the ambient outside temperature is too cold, then power to the solar panel fluid circuitry pump is switched off. Maintaining operation of renewable sources assists in providing back up power when the duration of standby power during prolonged mains power failure.

The UPS system is also wired to serve a small (16 Amp) ring main or radial circuit to provide essential power to items such as a fridge freezer, and a power socket for a kettle and/or toaster, or a microwave.

Optional features include a three way switch (manually or remotely controlled) to allow temporary power for critical equipment such as medical equipment or workshop stabling clinic or boost of an electric vehicle or such as a potable water pump as well as the maintained or maintained power to home based office facilities as well as fire or burglar alarm and selective lighting through the essential power board.

The standby power system is started by a normally closed relay, which on shut off of incoming power triggers a flow of power from the UPS, providing power to re-start a photovoltaic relay and the wind turbine or other renewable energy sources. With these brought online again, this creates a secondary source of power in addition to the energy stored in the UPS.

Additionally, a secondary power relay device at the distribution board switches to the UPS power cable. This can be done on automatically sensing a reduced or failed power supply at the mains power unit. This ensures essential power supply in the event that the integrated house wiring has failed due to for example an earth fault.

In this regard back feed preventers and local isolators as well as the automatic relay switches (G59 or equal) are installed to safeguard the incoming mains and the electrician during local repair work.

Size and weight considerations of the battery pack mean that the stand by power system is more readily suited to larger properties such as 3-5 bedroom houses, where there is a garage or utility room to house the UPS system. However, as battery technology becomes more compact, the UPS device may be reduced in size, to the size of a present conventional wall mounted gas central heating boiler, or around the size of a washing machine, dishwasher or other white goods appliance which fits under a kitchen work top.

The UPS system may also be fitted in large apartments, in stables, clinics or other properties having power requirements similar those of a domestic residence.

Solar arrays may be used indirectly to drive a wind turbine by means of a conventional stack effect ventilation funnel, for example as used in cooling towers or Arabian towers.

During installation, and by virtue of connecting different appliances to the standby power distribution board, a user can select which appliances or devices receive power and preference to others. For example, a fridge freezer, a pharmaceutical fridge, a dialysis machine or other essential equipment may be connected to the standby power distribution board to receive power in preference to lower priority applications such as storage heaters or outside lighting. The householder has flexibility in selecting (manually or remotely) which particular appliances or devices receive the reduced energy available from the UPS system, during times of mains power interruption.

### Operation of the Standby Power System During Normal Mains Supply

During normal operation i.e. most of the time, when the single phase or optional three phase main supply is supplying power to the household, the UPS 108 receives mains power, which is converted by the AC/DC converter to direct current, to keep the lithium batteries fully charged. Where the household is connected to renewable energy or low carbon sources, such as a wind turbine, a photovoltaic solar array, or a combined heat and power (CHP) electricity source, power from those devices combines with the mains power on the house side of the electricity meter, and therefore electricity from renewable energy sources may also be used to charge the battery pack.

During normal mains supply function, apart from taking power for topping up the batteries to keep them fully charged, the standby power system has a restricted effect on operation of the conventional domestic ring main and power usage of the household. Otherwise normal recharging of the standby power system (UPS) occurs at night during the maximum low tariff power input period.

### Operation of the Standby Power System During Power Cut

Under normal mains supply, power is supplied from the mains and from any local domestic renewable or low carbon electrical energy sources to all distribution boards, or any distribution board which are specifically wired up to receive mains power. On detecting a drop in mains voltage the control unit switches the output of the UPS 108 to feed the mains distribution board and the standby power distribution board.

Power to distribution boards which supply non-essential items such as Cookers storage heaters, Jacuzzis', saunas or the like and non essential ring mains are not fed with power by the UPS, and are switched out of circuit. For the main distribution board (in the case where a 3 phase supply and or a second back up UPS is available) and the essential (standby power) distribution board, these are switched by relay operated switches to receive power from the UPS and any renewables which are producing electricity. The control unit can be configured at installation, or retrospectively modified, so as to switch to both the mains distribution board and the standby distribution board, or alternatively to just the standby distribution board only. Hence the householder has the choice of restricting power to only essential devices attached to the standby circuits fed from the standby distribution board, or to the normal mains circuits fed by the main distribution board as well as any essential appliances feeding from the standby distribution board.

Back Feed Preventers

The power supply circuit comprises a plurality of back feed preventers BFP (G59 or equal) for preventing electricity leaking back into the mains power supply, when the mains power supply suffers a power cut.

During normal operation, when the mains grid is supplying power, if the renewable energy sources are generating enough electricity to satisfy the power needs of the distribution boards, then any additional generated electrical power can be fed back into the mains grid. Under these conditions, the relevant back feed preventer(s) BFP(s) and as type G59 or equal are temporarily disabled and allow power to be fed from the household back into the grid.

During conditions of mains power cut, the plurality of back feed preventers BFP activate to prevent any electricity supplied by the uninterruptible power supply, or the renewable energy sources being fed back into the mains power supply, thereby ensuring that the household electrical systems are effectively isolated from the mains power supply, until such time as mains power is restored, at which time the relevant back feed preventer (s) then disable, and allow any excess generated power from the household to be fed back into the main electricity power supply grid.

Interaction with Renewable Energy Sources

During a power cut, the mains supply 232 ceases to supply power. However, there may still be smaller amounts of electrical energy being supplied to the domestic circuit, on the household side of the main fuse 100 and electricity meter 101 by virtue of for example a combined heat and power boiler, photovoltaic solar array 105 and wind turbine 107 or a fuel cell. Additionally, further standby power may be supplied by depleting the batteries on parked electric vehicles, connected to the electric vehicle charging station 112, or by running the internal combustion engines on hybrid electric vehicles, to use those engines effectively as generators to feed into the domestic electricity circuit.

If any of these power sources are operating, they are in addition to the power supplied by the UPS unit. If not, then the UPS unit is the sole source of power during a mains power cut. Since the additional electrical energy sources may or may not be present, the UPS or other electrical storage system is the power supply of last resort for the household, during a mains power cut.

In addition, some electrical appliances may have their own inbuilt power supply which allows a limited duration of operation. For example laptop computers have an internal battery pack, and burglar alarm or fire alarm systems often have a small standby battery so that they continue to function for a short time during mains power cut. However, these sources of electrical power are specific to those individual devices, and are not available for general distribution or selective distribution to critical priority appliances, as is the power supplied by the household's standby (UPS) power supply.

During a mains power cut, the UPS supplies alternating current at mains frequency and voltage to the distribution boards 113-115 to maintain standby power to domestic circuits. At the same time, the UPS can receive power from a variety of renewable energy sources, including the photovoltaic array 105, wind turbine 107, and as necessary from the battery power supply of a parked electric vehicle.

### Universal Power Supply (UPS)

Typically, to maintain an emergency/standby power supply for domestic premises requires a current of 40 amps, with 85% diversity, giving it around 8 KVA. Demand may fluctuate down to around 35 amps, with 85% diversity, meaning a capacity of 9.14 KVA would be required. Consequently, enough lithium ion batteries must be provided within the uninterruptable power supply unit 108 to provide 7 to 8 KVA.

Since a domestic power cut typically lasts between 4 and 8 hours, the overall energy required to be supplied by the battery device is around 5 to 10 KW/h.

With the use of a three phase supply these ratings can be increased subject to available space with capacities of 10 kVA or more such that a full dialysis or electric vehicle charge and other critical loads can be achieved.

The embodiments include an optional 3 phase universal power supply battery system, and a backup universal power supply 149 of either single phase and/or 3 phase supply, to give an extra standby supply to the mains distribution board as well as to the essential function distribution boards 180.

Apparatus and method may include the option of a backup universal power supply unit, where space permits, to afford back up to the main distribution board as well as to the essential distribution board. This backup universal power supply unit can be optional for single phase and three phase where this is available, and particularly the farms and stables and veterinary practices as well as large residential properties and other establishments.

Interaction with Electric Vehicles

Typically, modern households have more than 1 vehicle, and if these are electric or internal combustion/electric hybrid vehicles, the on-board battery power supply of the electric vehicle can be used to supply extra power to the domestic electrical installation, via the uninterruptable power supply 108. Where there is more than one vehicle connected to the domestic electricity circuit, the user can select, by means of the re-charging circuitry 194, how many of the vehicles can be used to supply emergency power, so that at least one vehicle can be kept in reserve fully charged, so that the household maintains transport capability. For example a user may choose to run down the battery on an electric car, whilst maintaining power on an electric scooter so as to still have transport to get to work after the power cut. The householder has the choice of either using the energy stored in an electric or hybrid vehicle to supplement domestic electricity use, thereby running the vehicle batteries down, or using the energy stored in the household battery storage to charge the vehicle battery to maintain a transport facility, despite a mains power cut.

In the case of hybrid vehicles, having an internal combustion engine, a user may start the engine during a period of domestic power outage, effectively using the vehicle's engine as a generator to supply power to the domestic circuit or to charge the household battery pack.

Currently for most types of electric cars, a three-phase supply can charge an electric vehicle in 1 to 2 hours. For single phase supplies, the total charge time is typically 3 to 4 hours.

Should the single phase mains power fail, then only a ½ hour to 1 hour boost would be available from the universal power supply system.

In rural (non urban) areas, especially farms and large residences, a three-phase universal power supply would have to be installed to afford a one-hour charge for an electric car as a single phase top up might not ensure sufficient mileage to reach a public electric vehicle charge outlet point.

Interaction with Combined Heat and Power CHP Unit

A control system and emergency power supply, from the uninterruptable power supply is provided for any combined heat and power units which may be present in the building, so that if there is a mains power cut, the combined heat and power generator may keep operating, supplying power within the building in conjunction with the universal power supplies. Standby power is supplied to the distribution board from which the control system to the combined heat and power unit draws its electrical power. An optional combined heat and power and mains power auto changeover switch ACOS is provided as shown in FIG. 1, as is an auto transfer switch ATS.

### Control Loop and Remote Control

The power supply operates under control of a control device 151 (336) located at the UPS. The control device detects if there is a power cut or power outage at the mains power supply, and if there is, activates the flow of stored DC energy and converts it back to AC using an inverter, The back feed preventers BFP effectively isolate the distribution boards and universal power supplies from the mains supply, whilst the mains power is cut. A system of power switching occurs by means of normally closed relays such as (A1 &B2) where the standby power circuitry links to the incoming supply circuit.

Further, individual aspects of operation of the circuit can be operated by remote control device, and/or a programmable controller device, and a control wiring loop 152 (335) can be incorporated to serve each system component thereby allowing monitoring, and to send test and restart signals especially to the photovoltaic array, wind turbine, hot water system solar panel, combined heat and power and to other renewable energy device local controllers.

### Isolators E1, E2, E3

The isolators include a first isolator E1 which is single phase circuit to electric vehicle charging point; a second isolator E2 which is single phase 2 universal power supply; a third isolator E3 which is a bad 3 phase to universal power supply system; a fourth isolator E4 which is a three phase to electric vehicle charging point; and further isolators E5 which are local isolators to all single or three phase supplies at powered units, to comply with electrical safety standards.

Features of the above installation include the following:

A universal (uninterruptable) power supply fed from an economy ten incoming power supply during night hours in the afternoon, with evening boost.

The universal power supply is of a suitable compact size to fit in a utility room, cupboard, etc.

The universal power supply provide standby power to houses, large apartments, stables, farms, and clinics.

In addition, once a power outage occurs, the universal power supply can be fed from renewable electrical supplies such as photovoltaic arrays, (daytime), and wind turbines (24/7) etc.

The universal power supply is triggered when an outage or power failure in the home occurs.

The circuit is such that the universal power supply provide standby kick-start to the photovoltaic array and wind turbine when incoming power has failed.

The solar arrays can be used indirectly to drive the turbine by means of a state-of-the-art stack effect of ventilation funnel, for example as for cooling towers or Arabian towers.

Such backup supply to the renewables is made via timers that ensure power only goes to solar arrays and solar (HWS) panels during daylight hours. And the latter, only when there is enough air temperature differential to benefit the hot water system.

The universal power supply would normally provide power to process plant or a computer suite. However, the domestic wiring circuit allows for local or remote switching to server workshop PowerPoint or a garage, or indeed stables, or specifically, to charge an electric car.

In addition, there is an option to serve a dialysis unit in a private house. These come in addition to serving a fridge freezer power point, these being dependent on load and choice of essential power protection at the time.

In addition, there is an option to serve dialysis unit in a private house, clinic or in a nursing home and specifically to a pharmaceutical drugs fridge.

The universal power supply serves a dedicated distribution board from which all of the above are captured.

The universal power supply was to provide standby power to the lighting circuits that are available 24/7. It provides power to the 1 to 2 hour backup power supply units serving the burglar and security alarms. The PC/laptop in the home can also be linked via a 1 to 2 hour backup state-of-the-art mini universal power supply.

All of the above are dependent on the load and choice of essential power protection at the time of a power supply outage or a power failure in the house.

The use of a new E10 (previously called economy 7) reduced rate electricity meter for the system is optional, and depends upon the universal power supply recharging load and timescale, some requiring up to 5 hours boost each day. An additional benefit would be the afternoon and evening boost to keep the universal power supply charged.

Where the E10 metre is fitted to serve the universal power supply, it will be opportune to have backup electrical storage heaters as a reserve heat source if the heating boilers have gone off.

The circuit switches and controllers form an integral part of the concept and maximise the flexibility of the system with choice of specific power outlets. This would suit the needs of the family at the time of power outage, whatever time of day. The circuit switches, controllers and the optional remote smart type controller can also be linked to an optional monitor and signal wired control loop system 152 (335).

When working to a nominal 8 kVA “battery pack”, this will be about the size of a fridge freezer if implemented as a stack of lithium batteries. This will have fifty-eight minutes normal power/and peerage, boosted by the photovoltaic cells, wind power generators and other renewable energy sources.

For the optional 3 phase UPS or single phase with a second Back Up UPS then more space would be necessary for a large utility room, garage or store.

1. A standby domestic power supply for a domestic premises, comprising:
a battery storage device;
an AC/DC converter for converting between a direct current and alternating mains current; and
a control system for controlling interaction of the battery storage device with one or a plurality of domestic electrical circuits and/or electrical devices.

2. The domestic power supply according to claim 1, wherein
said battery pack is capable of supplying between 5 KVA and 10 KVA.

3. (canceled)

4. (canceled)

5. The domestic power supply according to claim 1, further comprising a charging circuit capable of charging said batteries from a single phase mains electricity supply.

6. The domestic power supply according to claim 1, wherein said battery comprises an array of Lithium batteries.

7. The domestic power supply according to claim 1, comprising a dedicated standby electricity distribution board for distributing power to a plurality of selected essential appliances or devices.

8. The domestic power supply according to claim 1 comprising a white-goods type housing capable of fitting under a conventional kitchen work surface.

9. The domestic power supply according to claim 1, wherein said control system is operable to select a set of higher priority electrical devices in preference to a set of lower priority electrical devices for receiving energy supplied by said battery.

10. The domestic power supply according to claim 1, comprising a plurality of switches for switching between said mains supply and said battery storage device.

11. The domestic power supply according to claim 1, comprising a plurality of sensors for directing an output of one or more local electricity generation devices to a standby electricity distribution board, under conditions of mains power failure.

12. The domestic power supply according to claim 1, comprising a plurality of sensors and switches for redirecting the output of one or a plurality of local renewable or low carbon electricity generating devices to a mains distribution board under conditions of mains power failure.

13. The domestic power supply according to claim 1, wherein said renewable energy sources comprise devices selected form the following set:
wind turbine generators;
water turbine generators;
photovoltaic solar cells;
fuel cells;
combined heat and power (CHP) generators;
electric vehicles.

14. The domestic power supply according to claim 1, further comprising a backup universal power supply.

15. (canceled)

16. The domestic power supply according to claim 1, comprising a remote control device.

17. The domestic power supply according to claim 1, comprising a control loop apparatus for controlling supply of power from a said universal power supply under conditions of mains power outage, for controlling charging of a said universal power supply, under conditions of mains power outage, and for controlling charging of a said universal power supply under normal mains power operation.

18. The domestic power supply according to claim 1, comprising one or a plurality of back feed preventers, for preventing feedback of electrical power from the installation to the mains under conditions of mains power supply failure or outage.

19. A method of supplying standby power to a domestic premises during a mains power cut, said method comprising:
storing electrical energy in a battery or equivalent storage device located in said domestic premises;
detecting a power cut or failure in said domestic premises;
in response to said detected mains power cut, supplying energy from said battery pack to a selected set of domestic electric circuits and devices.

20. The method as according to claim 19, comprising supplying energy to a dedicated standby power distribution board connected to said circuits.

21. The method as claimed in claim 19, further comprising selectively controlling power supplied to one or a plurality of electrical devices to optimise power usage during a period of mains supply power cut.

22. The method as claimed in claim 19, comprising selectively deactivating selected appliances or electrical devices to conserve power for use by more important selected appliances or devices.

23. The method as claimed in claim 19, comprising detecting a darkness condition, and restricting power supplied to a solar panel during a period of said darkness.

24. (canceled)
